(19) United States
(12) Patent Application Publication
(10) Pub. No.: US 2013/0221903 A1
(43) Pub. Date: Aug. 29, 2013

(54) BATTERY CHARGING DEVICE AND METHOD

(71) Applicant: Samsung SDI Co., Ltd., (US)

(72) Inventors: Doo-Sun Hwang, Yongin-si (KR); Kwang-Sig Jung, Yongin-si (KR); Kyeong-Beom Cheong, Yongin-si (KR); Jae-Seung Ryu, Yongin-si (KR); Kyung-Won Seo, Yongin-si (KR); Hyung-Hoon Lim, Yongin-si (KR); Woo-Choul Kim, Yongin-si (KR); Yong-Uk Kim, Yongin-si (KR)

(73) Assignee: SAMSUNG SDI CO., LTD., Yongin-si (KR)

(21) Appl. No.: 13/670,298

(22) Filed: Nov. 6, 2012

(30) Foreign Application Priority Data
Feb. 28, 2012 (KR) 10-2012-0020257

(51) Int. Cl. H02J 7/00

(52) U.S. Cl. 320/107; 320/137; 320/162

(57) ABSTRACT

A battery charger, including: a sensor for monitoring a degree of deterioration of a secondary battery; a current driver for applying a current to the secondary battery; and a controller for controlling the current applied to the secondary battery from the current driver, receiving the degree of deterioration of the secondary battery from the sensor, and determining whether to change or maintain the current applied to the secondary battery according to the degree of deterioration of the secondary battery.

### RELATED APPLICATIONS

This application claims priority to and the benefit of Korean Patent Application No. 10-2012-0020257, filed on Feb. 28, 2012, in the Korean Intellectual Property Office, the entire content of which is incorporated herein by reference.

### BACKGROUND

1. Field

Aspects of embodiments of the present invention relate to a battery charger for a secondary battery and a battery charging method.

2. Description of the Related Art

Secondary batteries have been used as power sources of portable electronic devices in many fields, and, demand on secondary batteries has increased. The secondary batteries may be charged and discharged several times and, thus, may be economically and environmentally effective. Accordingly, the use of the secondary batteries has increased.

A secondary battery may be charged using a method of setting a certain voltage to a charging voltage, charging the secondary battery with a certain current value until the charging voltage reaches the set voltage, and decreasing the charging current after the secondary battery reaches the set voltage. As the charging/discharging of the secondary battery continues, a reaction between an electrolyte and an electrode plate may occur inside the secondary battery. Therefore, when the charging/discharging cycle of the secondary battery is repeated, the secondary battery may be gradually deteriorated, and the voltage and capacity of the secondary battery may decrease.

### SUMMARY

Embodiments of the present invention provide a battery charger directed toward increasing the lifetime of a secondary battery by controlling an appropriate charging current according to a degree of deterioration of the secondary battery.

Embodiments of the present invention also provide a battery charging method directed toward charging a secondary battery with high efficiency.

According to aspects of embodiments of the present invention, there is provided a battery charger, including: a sensor configured to monitor a degree of deterioration of a secondary battery; a current driver configured to apply a current to the secondary battery; and a controller configured to control the current applied to the secondary battery from the current driver, receive the degree of deterioration of the secondary battery from the sensor, and determine whether to change or maintain the current applied to the secondary battery according to the degree of deterioration of the secondary battery.

The controller may be configured to determine the current applied to the secondary battery according to a first mode, a second mode, or a third mode.

The controller may be configured to select the first mode, the second mode, or the third mode may by comparing a charging capacity estimation value determined according to the current applied to the secondary battery with a charging capacity target value of the secondary battery, the controller may be configured to select the second mode or the third mode when the charging capacity estimation value exceeds the charging capacity target value, and the controller may be configured to select the first mode when the charging capacity estimation value is the charging capacity target value or less.

In one embodiment, the controller is configured to: determine the current by the second mode or the third mode when a state of health (SOH) in Equation 1 is 10 W % (n being a natural number of 0<n<10); determine the current by the first mode when the SOH is not 10 n % (n being a natural number of 0<n<10); and select either the second mode or the third mode by comparing a charging capacity estimation value determined according to the current applied to the secondary battery with a charging capacity target value of the secondary battery, with the current being determined by the second mode when the charging capacity estimation value exceeds the charging capacity target value, and with the current being determined by the third mode when the charging capacity estimation value is the charging capacity target value or less. In one embodiment, Equation 1 is SOH=(Cap./Cap.ᵢₙₜ)*100, wherein Cap. denotes a discharging capacity of the secondary battery, and Cap.ᵢₙₜ denotes a designed capacity of the secondary battery.

The controller may be configured to select the first mode, the second mode, or the third mode by comparing a charging time estimation value determined according to a charging capacity estimation value with a charging time target value of the secondary battery. The current may be determined by the second mode or the third mode when the charging time estimation value is less than the charging time target value, and the current may be determined by the first mode when the charging time estimation value is the charging time target value or more.

The controller may be configured to, in the first mode, maintain the current applied to the secondary battery to be substantially similar to that previously applied to the secondary battery.

The controller may be configured to, in the second mode and the third mode, decrease the current applied to the secondary battery as compared with that previously applied to the secondary battery.

The controller may be configured to, in the second mode, decrease the current applied to the secondary battery to a reference current value according to the degree of deterioration of the secondary battery.

The controller may be configured to, in the third mode, decrease, in real time, the current applied to the secondary battery according to the degree of deterioration of the secondary battery, changed in real time. In one embodiment, controller is configured to, in the third mode, decrease the current applied to the secondary battery so that the slope of the change in magnitude of the of the current is inclined according to the degree of deterioration of the secondary battery.

According to another aspect of embodiments of the present invention, there is provided a battery charging method, including: determining a degree of deterioration of a secondary battery during a battery monitoring operation; determining whether to maintain or change a current applied to the secondary battery according to the degree of deterioration of the secondary battery during a current determining operation; and charging the secondary battery with the current determined in the current determining step during a battery charging operation.

During the battery monitoring operation, determining the degree of deterioration of the secondary battery may comprise measuring a voltage or the current of the secondary battery.

During the current determining operation, the current applied to the secondary battery may be determined by a first mode, a second mode, or a third mode of determining the current.

The battery charging method may further include, during the current determining operation: comparing a charging capacity estimation value determined according to the current applied to the secondary battery with a charging capacity target value of the secondary battery; determining the current by the second mode or the third mode when the charging capacity estimation value exceeds the charging capacity target value; and determining the current the first mode when the charging capacity estimation value is the charging capacity target value or less.

During the current determining operation: when a state of health (SOH) in Equation 1 is 10 n % (n being a natural number of 0<n<10), the current applied to the secondary battery may be determined by either the second mode or the third mode, the second mode or the third mode may be selected by comparing the charging capacity estimation value determined by the current applied to the secondary battery with a charging capacity target value of the secondary battery; when the charging capacity estimation value exceeds the charging capacity target value, the current may be determined by the second mode; and when the charging capacity estimation value is the charging capacity target value or less, the current may be determined by the third mode. In one embodiment, Equation 1 is SOH=(Cap./Cap.ᵢₙₜ)*100, wherein Cap. denotes a discharging capacity of the secondary battery, and Cap.ᵢₙₜ denotes a designed capacity of the secondary battery.

The battery charging method may further include: charging the secondary battery with the current determined by a first mode, a second mode, or a third mode of determining the current during the battery charging operation; during the first mode, maintaining the current applied to the secondary battery to be identical to that previously applied to the secondary battery, and during the second mode and third mode, decreasing the current applied to the secondary battery as compared with that previously applied to the secondary battery.

The battery charging method may further include: during the second mode, decreasing the current applied to the secondary battery to a reference current value according to the degree of deterioration of the secondary battery, and during the third mode, decreasing, in real time, the current applied to the secondary battery according to the degree of deterioration of the secondary battery, changed in real time.

As described above, according to embodiments of the present invention, it is possible to provide a battery charging device directed toward increasing the lifetime of a secondary battery by controlling an appropriate charging current according to the degree of deterioration of the secondary battery.

Further, it is possible to provide a battery charging method directed toward charging a secondary battery with high efficiency.

### BRIEF DESCRIPTION OF THE DRAWINGS

The accompanying drawings, together with the specification, illustrate exemplary embodiments of the present invention, and, together with the description, serve to explain aspects of embodiments of the present invention.

FIG. 1 is a block diagram schematically showing a battery charging device according to an embodiment of the present invention.

FIG. 2 is a block diagram schematically illustrating a function of a control unit shown in FIG. 1.

FIG. 3(a) is a graph showing a current applied to a secondary battery, determined by first and second modes, according to a degree of deterioration of a secondary battery, and FIG. 3(b) is a graph showing the current applied to the secondary battery, determined by first to third modes, according to the degree of deterioration of the secondary battery.

FIG. 4 is a block diagram schematically illustrating a function of a control unit according to another embodiment of the present invention.

FIG. 5 is a graph showing the current applied to the secondary battery, determined by first to third modes, according to the function of the control unit in FIG. 4.

FIG. 6 is a flowchart illustrating a battery charging method according to an embodiment of the present invention.

FIG. 7A is a graph showing a charging time with respect to a state of health (SOH).

FIG. 7B is a graph showing a charging current with respect to the SOH.

FIG. 8 is a graph showing lifetimes according to an embodiment of the present invention and a comparative example.

### DETAILED DESCRIPTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. In addition, when an element is referred to as being “on” another element, it may be directly on the another element or be indirectly on the another element with one or more intervening elements interposed therebetween. Also, when an element is referred to as being “connected to” another element, it may be directly connected to the another element or be indirectly connected to the another element with one or more intervening elements interposed therebetween. Hereinafter, like reference numerals refer to like elements.

Hereinafter, exemplary embodiments of the present invention will be described with reference to the accompanying drawings.

FIG. 1 is a block diagram schematically showing a battery charging device according to an embodiment of the present invention.

The battery charging device (e.g., a battery charger) according to this embodiment includes a sensing unit 300 (e.g., a sensor) monitoring a degree of deterioration of a secondary battery 100, a current application unit 200 (e.g., a current driver) applying a current to the secondary battery 100, and a control unit 400 (e.g., a controller) controlling the current applied to the secondary battery 100 from the current application unit 200. The control unit 400 may receive the degree of deterioration of the secondary battery 100 from the sensing unit 300 and may determine whether to change or to maintain the current applied to the secondary battery 100 according to the degree of deterioration of the secondary battery 100.

The secondary battery 100 may be manufactured by disposing an electrode assembly and an electrolyte inside a battery case. The electrode assembly may be manufactured by, for example, winding or stacking a positive electrode plate, a negative electrode plate, and a separator interposed between the positive and negative electrode plates. The positive and negative electrode plates may cause the movement (e.g., transfer) of electrons by reacting with the electrolyte, and, accordingly, may generate electrochemical energy. Although a protective circuit module, etc., which may be provided with the secondary battery 100, is not mentioned in this embodiment, the present invention is not limited thereto. That is, the secondary battery 100 may include various energy systems capable of performing reversible charging/discharging.

The secondary battery 100 may be charged/discharged numerous times, and the positive and negative electrode plates may react with the electrolyte in the charging/discharging process. As the number of the charging/discharging operations increases, an ancillary (or side) reaction occurs when the positive and negative electrode plates react with the electrolyte. The ancillary reaction may cause deterioration of the secondary battery 100. That is, the deterioration of the secondary battery 100 may be caused in the charging/discharging process of the secondary battery 100. The deterioration of the secondary battery 100 may decrease the discharging capacity of the secondary battery 100, etc., and the lifetime of the secondary battery 100 may be reduced. If the deteriorated secondary battery 100 is charged by a charging method which does not consider the degree of deterioration of the secondary battery 100, the deterioration of the secondary battery 100 may be accelerated.

Aspects of embodiments of the present invention relate to a battery charging device and method directed toward preventing (or substantially preventing) the deterioration of a secondary battery from being accelerated, and more particularly, to a battery charging device and method directed toward reducing or minimizing the deterioration of the secondary battery by applying an appropriate current to the secondary battery when the secondary battery is being charged. If the deterioration of the secondary battery occurs (e.g., occurs even once), the speed of the deterioration may rapidly increase due to characteristics of the secondary battery. In a serious case, the charging/discharging of the secondary battery may become impossible (or impracticable), and therefore, the secondary battery may not be used (or practically may not be used) any more. On the other hand, when a secondary battery is charged using the battery charging device or method according to embodiments of the present invention, it is possible to prevent (or substantially prevent) the deterioration of the secondary battery from being accelerated while the secondary battery is charged/discharged, and, thus, the lifetime of the secondary battery may be improved. Further, the current applied to the secondary battery may be reduced according to the degree of degradation of the secondary battery, and the time taken to charge the secondary battery may be optimized or improved, thereby improving the charging efficiency of the secondary battery.

The current application unit 200 is used to apply the current to the secondary battery 100, and may be controlled by the control unit 400. The current applied to the secondary battery 100 from the current application unit 200 may be controlled according to the degree of deterioration of the secondary battery 100. For example, the applied current may be controlled according to a change in a degree of deterioration of the secondary battery 100. The degree of deterioration of the secondary battery 100 may be determined by using a discharging capacity (e.g., a discharging capacity obtained after the current secondary battery 100 is charged), with respect to an initial designed capacity of the secondary battery 100 (e.g., a capacity specified by the manufacturer).

In one embodiment, the sensing unit 300 monitors a voltage and/or the current of the secondary battery 100 and transfers (or transmits) the degree of deterioration of the secondary battery 100 to the control unit 400. Then, the control unit 400 may determine the appropriate charging current according to the degree of deterioration of the secondary battery 100. The control unit 400 may also change or maintain the current applied to the secondary battery 100 (e.g., change or maintain the current currently applied to the secondary battery 100 with respect to the current previously applied to the secondary battery 100) by controlling the current application unit 200.

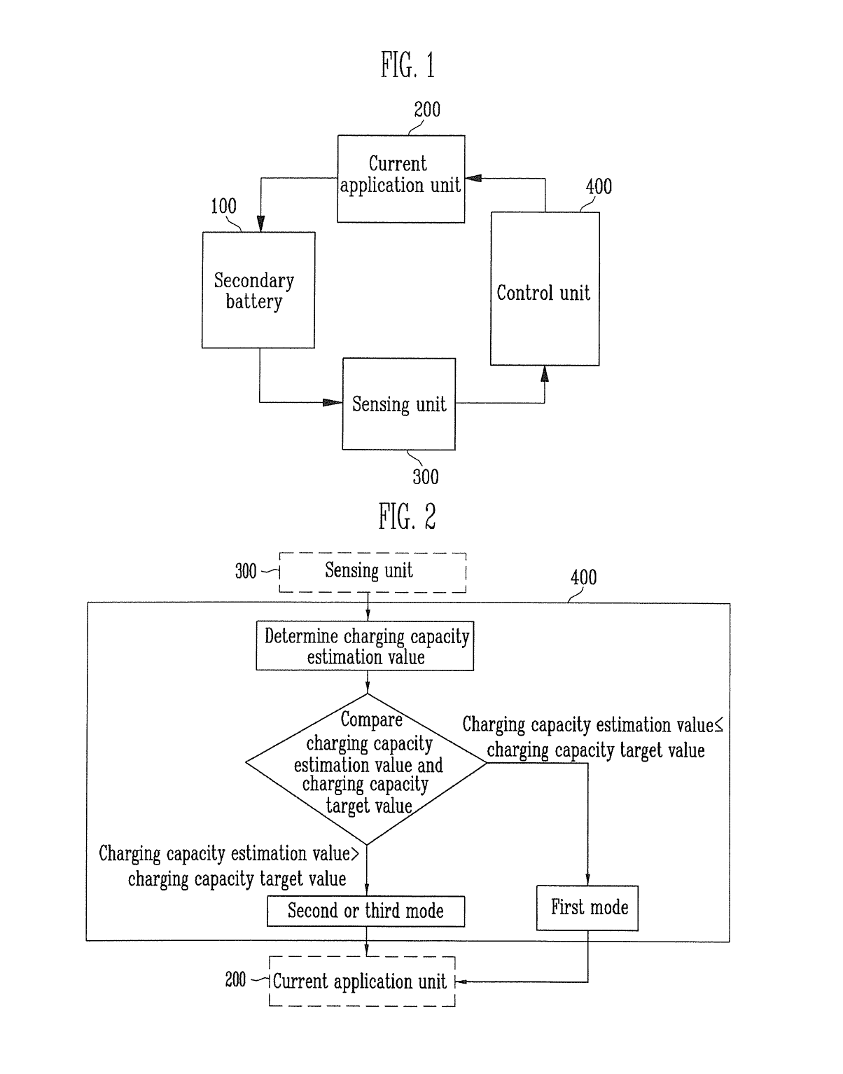

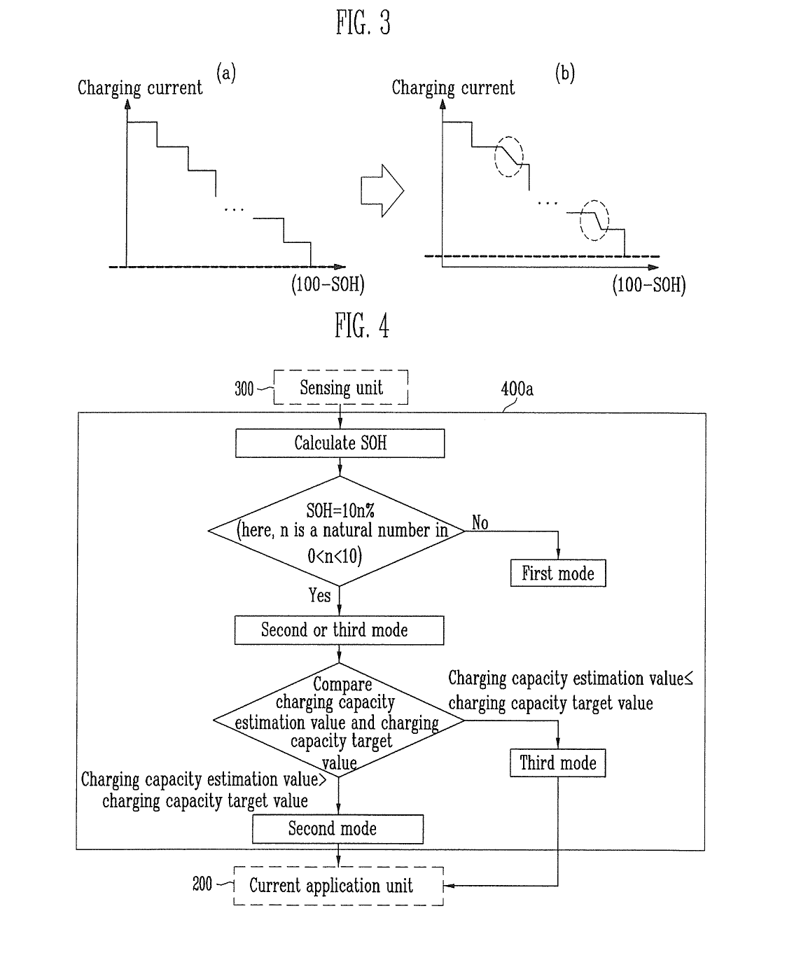

FIG. 2 is a block diagram schematically illustrating a function of the control unit shown in FIG. 1.

Referring to FIG. 2, the control unit 400 may receive the degree of deterioration of the secondary battery 100 from the sensing unit 300, may determine the current to be applied to the secondary battery 100, and may transmit the determined result to the current application unit 200. The control unit 400 may control the current applied to the secondary battery 100 according to first to third modes (i.e., a first mode, a second mode, or a third mode).

The first to third modes of determining the current applied to the secondary battery 100 in the control unit 400 may be selected by comparing a charging capacity target value of the secondary battery 100 with a charging capacity estimation value determined according to the current applied to the secondary battery 100. When the charging capacity estimation value exceeds the charging capacity target value, the current may be determined by the second or third mode. When the charging capacity estimation value is the charging capacity target value or less, the current may be determined by the first mode.

The control unit 400 may determine the charging capacity estimation value of the secondary battery 100 based on information transferred by the sensing unit 300. For example, the charging capacity estimation value may be determined by the current applied to the secondary battery 100, the voltage of the secondary battery 100, or the like. That is, the control unit 400 may determine the charging capacity estimation value based on the current currently applied to the secondary battery 100, and the first to third modes may be determined by comparing the charging capacity estimation value with the charging capacity target value. In one embodiment, the charging capacity target value refers to a capacity of the secondary battery 100 to be charged.

When comparing the charging capacity estimation value with the charging capacity target value, the control unit 400 may select to use the second or third mode when the charging capacity estimation value exceeds the charging capacity target value, and the control unit 400 may select to use the first mode when the charging capacity estimation value is the charging capacity target value or less. The first mode may include, for example, maintaining the current applied to the secondary battery 100 to be identical to the current previously applied to the secondary battery 100, and the second or third mode may include, for example, decreasing the current applied to the secondary battery 100 as compared with the current previously applied to the secondary battery 100.

The secondary battery 100 may be deteriorated during charging of the secondary battery 100, but the deterioration of the secondary battery 100 may not be continuous in real time. When the current applied to the secondary battery 100 is decreased, the charging time of the secondary battery 100 may be increased proportionally to (or as much as) the decrease in the current applied to the secondary battery 100. Therefore, the current applied to the secondary battery 100 may be adjusted or optimized so that a total charging time of the secondary battery 100 may not be unnecessarily or inefficiently increased while reducing or minimizing the deterioration of the secondary battery 100. According to embodiments of the present invention, the current applied to the secondary battery 100 may be maintained in the first mode or may be decreased in the second mode or the third mode according to the degree of deterioration of the secondary battery 100 so that it is possible to improve the lifetime of the secondary battery 100 and to have an improved charging efficiency of the secondary battery 100.

When the charging capacity estimation value is the charging capacity target value or less, the control unit 400 may select the first mode. When the current applied to the secondary battery 100 is decreased, the charging capacity target value of the secondary battery 100 may not be satisfied. Therefore, the current applied to the secondary battery 100 in the first mode is not decreased but is, instead, maintained in order to satisfy (or closely satisfy) the charging capacity target value. That is, when the current applied to the secondary battery 100 is decreased (e.g., decreased by the second or third mode), the secondary battery 100 does not reach the charging capacity target value, and hence the current is continuously applied (e.g., a previous current is maintained) to the secondary battery 100 to prevent (or substantially prevent) the deterioration of the secondary battery 100 from accelerating.

When the charging capacity estimation value exceeds the charging capacity target value, the control unit 400 may select the second or third mode so as to decrease the current applied to the secondary battery 100. Because the current applied to the secondary battery 100 may sufficiently reach the charging capacity target value, it is possible to prevent (or substantially prevent) the deterioration of the secondary battery 100 by decreasing the current applied to the secondary battery 100.

As such, in one embodiment, the control unit 400 selects the first mode or selects the second mode or the third mode by comparing the charging capacity estimation value with the charging capacity target value, so that it is possible to improve or optimize (e.g., select an efficient value for) the current applied to the secondary battery 100. The current applied to the secondary battery 100 may be decreased by the second or third mode. The second mode may include decreasing the value of the current applied to the secondary battery 100 to a reference (e.g., a reference current value or a value calculated by and/or stored in the control unit 400 or sensing unit 300) according to the degree of deterioration of the secondary battery 100. The third mode may include decreasing, in real time, the current applied to the secondary battery 100 according to the degree of deterioration of the secondary battery 100, which is changed (and/or measured/monitored) in real time. In one embodiment, the reference current value refers to a current value initially set by the control unit, and is determined as an appropriate current value by a mathematical calculation using a simulation, or the like, according to the degree of deterioration of the secondary battery 100.

While both the second and third modes include decreasing the current applied to the secondary battery 100, the method of decreasing the current in the second mode is different from the method of decreasing the current in the third mode. In one embodiment, the second mode includes decreasing the value of the current applied to the secondary battery 100 to the reference current value. The second mode may include changing the value of the current applied to the secondary battery 100 to the reference current value. That is, in the second mode, the value of the current applied to the secondary battery 100 may be decreased (e.g., stepwise-decreased) to the reference current value suitable for a degree of deterioration of the secondary battery 100 at a point in time according to the degree of deterioration of the secondary battery 100.

On the other hand, the third mode may include continuously (or continually) decreasing the current applied to the secondary battery 100. That is, the control unit 400 may decrease the current applied to the secondary battery 100 in real time by measuring a degree of deterioration of the secondary battery 100 in real time, rather than at a point of time (e.g., periodically).

FIG. 3(a) is a graph showing the current applied to the secondary battery by the first and second modes according to the degree of deterioration of the secondary battery, and FIG. 3(b) is a graph showing the current applied to the secondary battery by the first to third modes according to the degree of deterioration of the secondary battery.

FIG. 3(a) shows a graph in which the current applied to the secondary battery 100 according to the degree of deterioration of the secondary battery 100 is determined by the first or second mode. In the graph of FIG. 3(a), as the degree of deterioration of the secondary battery 100 increases (e.g., when the state of health (SOH) decreases), the charging current that is currently applied to the secondary battery 100 decreases. In the embodiment illustrated in FIG. 3(a), the tendency of the decrease in the charging current is shown in a stepped form. That is, the charging current may be maintained (e.g., the first mode) or decreased (e.g., the second mode) according to the degree of deterioration of the secondary battery 100 at a point in time. In one embodiment, the control unit 400 selects one of the reference (e.g., preset) current values calculated according to the degree of deterioration of the secondary battery 100, and, accordingly, the current applied to the secondary battery 100 is deceased, thereby decreasing the charging current. The current applied to the secondary battery 100 may be maintained at the decreased current value for a period of time (e.g., a set period of time) until the degree of deterioration of the secondary battery 100 is again measured (e.g., periodically measured)).

FIG. 3(b) shows a graph in which the current applied to the secondary battery according to the degree of deterioration of the secondary battery is determined by the first to third modes. In the graph of FIG. 3(b), as the secondary battery 100 is deteriorated (e.g., when the state of health (SOH) decreases), the charging current applied to the secondary battery 100 decreases. The tendency of the decrease in the charging current is different from that in FIG. 3(a). For example, the third mode (which is not used in the embodiment illustrated in FIG. 3(a)) may include measuring a degree of deterioration of the secondary battery 100 in real time and decreasing the charging current in real time according to the measured degree of deterioration of the secondary battery 100. For example, the third mode may include decreasing the current applied to the secondary battery 100 so that the slope of the magnitude of current as plotted on a graph is inclined (e.g., inclined downward or declined) according to the degree of deterioration of the secondary battery 100.

Hereinafter, another embodiment of the present invention will be described. Some aspects of this embodiment, are similar (or substantially similar) to the embodiments previously described in connection with FIGS. 1 to 3, and therefore, their detailed descriptions are given by way of reference to the above-recited embodiments of the present invention.

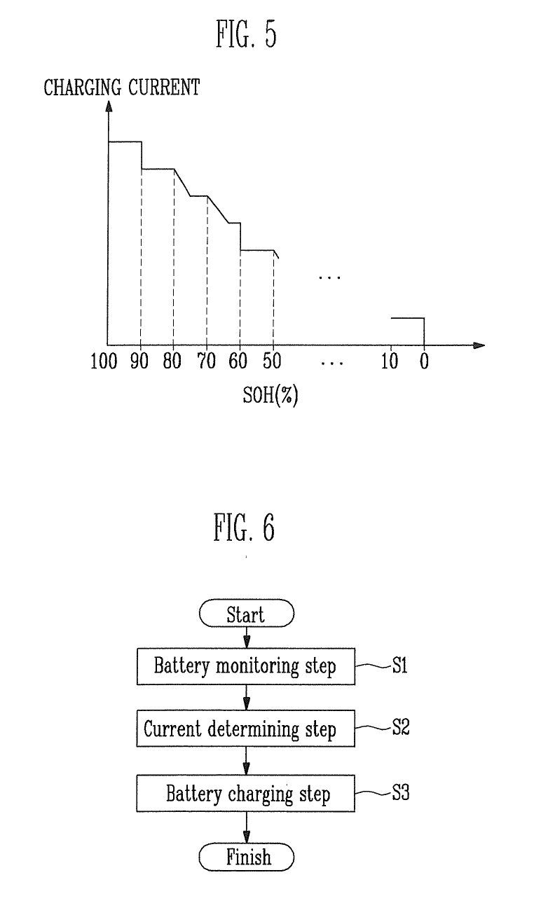

FIG. 4 is a block diagram schematically illustrating a function of a control unit according to another embodiment of the present invention.

Referring to FIG. 4, a control unit 400a (e.g., a controller) according to an embodiment may receive the degree of deterioration of the secondary battery 100 from the sensing unit 300 (e.g., the sensor) and control current applied to the secondary battery 100 from the current application unit 200 (e.g., the current driver) according to the degree of deterioration of the secondary battery 100. The control unit 400a may allow the current applied to the secondary battery 100 to be determined by first to third modes (i.e., a first mode, a second mode, or a third mode).

The control unit 400a may select the first to third modes in consideration of a state of health (SOH) according to Equation 1. In one embodiment, when the SOH is 10 n % (n is a natural number of 0<n<10), the current applied to the secondary battery 100 is determined by the second or third mode, and when the SOH is not 10 n % (n is a natural number of 0<n<10), the current applied to the secondary battery 100 is determined by the first mode. The second or third mode may be selected by comparing a charging capacity target value with a charging capacity estimation value determined (e.g., calculated) according to the current applied to the secondary battery 100. When the charging capacity estimation value exceeds the charging capacity target value, the current applied to the secondary battery 100 may be determined by the second mode. When the charging capacity estimation value is the charging capacity target value or less, the current applied to the secondary battery 100 may be determined by the third mode.

SOH=(Cap./Cap.ᵢₙₜ)*100 Equation 1:

In one embodiment, Cap. denotes a discharging capacity of the secondary battery 100, and Cap.ᵢₙₜ denotes a designed capacity of the secondary battery 100.

The designed capacity Cap.ᵢₙₜ may be a target capacity of the secondary battery 100 when the secondary battery 100 is initially manufactured, and may be implemented by appropriately controlling (e.g., varying aspects of), for example, the positive electrode plate, the negative electrode plate, and the like. The discharging capacity Cap. is a capacity obtained by charging the secondary battery 100, which may be deteriorated due to the continuous use of the secondary battery 100 and/or discharging the secondary battery 100. That is, the SOH may be represented as a percentage of the designed capacity Cap.ᵢₙₜ of the secondary battery 100 with respect to the discharging capacity Cap. of the secondary battery 100. Therefore, as the secondary battery 100 deteriorates, the discharging capacity Cap. of the secondary battery 100 may decrease as compared with the designed capacity Cap.ᵢₙₜ of the secondary battery 100.

FIG. 5 is a graph showing the current applied to the secondary battery, determined by first to third modes, according to the function of the control unit in FIG. 4.

Referring to FIG. 5, when the SOH is not 10 n % (n is a natural number of 0<n<10) according to Equation 1, the control unit 400a may select the first mode. When the SOH is 10 n % (n is a natural number of 0<n<10) according to Equation 1, the control unit 400a may select the second or third mode. For example, when the SOH is 90%, 80%, 70%, . . . or 10%, the control unit 400a may select the second mode or the third mode.

In one embodiment, when the SOH is not 90%, 80%, 70%, . . . or 10%, the charging current that is currently applied to the secondary battery 100 is maintained by the first mode. In one embodiment, when the SOH is 90%, 80%, 70%, . . . or 10%, the charging current is decreased by the second mode or the third mode. For example, in FIG. 5, the charging current illustrated as being decreased by the second mode when the SOH is 10%, and the charging current being decreased by the third mode when the SOH is 20%, 30%, . . . or 90%.

According to still another embodiment of the present invention, the second mode or the third mode may be selected (i.e., one of either the first mode or the second mode may be selected) according to the charging capacity estimation value and charging capacity target value of the secondary battery 100. For example, the second mode or the third mode may be selected by determining a charging capacity estimation value and then comparing the determined charging capacity estimation value with the charging capacity target value. When the charging capacity estimation value exceeds the charging capacity target value, the current applied to the secondary battery 100 may be determined by the second mode. When the charging capacity estimation value is the charging capacity target value or less, the current applied to the secondary battery 100 may be determined by the third mode.

The time taken to charge the secondary battery 100 may be determined according to the charging capacity estimation value and the current, which may be referred to as a charging time estimation value. As described above, when the secondary battery 100 is charged for a period of time longer than a charging time target value that is a target charging time, the deterioration of the secondary battery 100 may be accelerated, and the charging efficiency of the secondary battery 100 may be decreased.

Therefore, the first to third modes may be selected according to the charging time estimation value and the charging time target value. For example, the first to third modes may be selected by comparing the charging time estimation value determined by the charging capacity estimation value with the charging time target value of the secondary battery 100. When the charging time estimation value is less than the charging time target value, the current applied to the secondary battery 100 may be determined by the second mode or the third mode. When the charging time estimation value is the charging time target value or more, the current applied to the secondary battery 100 may be determined by the first mode.

FIG. 6 is a flowchart illustrating a battery charging method according to an embodiment of the present invention.

The battery charging method according to this embodiment may include a battery monitoring operation (S1) including monitoring a degree of deterioration of a secondary battery; a current determining operation (S2) including maintaining or changing a current applied to the secondary battery according to the degree of deterioration of the secondary battery monitored in the battery monitoring operation (S1); and a battery charging operation (S3) including charging the secondary battery with the current determined in the current determining operation (S2).

In the battery monitoring operation (S1), the degree of deterioration of the secondary battery may be determined by measuring a voltage or the current of the secondary battery. For example, a sensing unit may be coupled to the secondary battery (e.g., connected to the secondary battery through a wire), may measure the voltage or the current of the secondary battery, and may determine (e.g., calculate) the degree of deterioration of the secondary battery according to the measured voltage or current of the secondary battery.

The current determining operation (S2) may include controlling the current applied to the secondary battery to be determined by first to third modes (i.e., a first mode, a second mode, or a third mode). In the current determining operation (S2), the first to third modes may be selected according to the degree of deterioration of the secondary battery, provided, for example, from the sensing unit. Accordingly, the secondary battery may be charged according to the selected mode.

The method of selecting the first to third modes may include a first method and/or a second method.

In the first method, the first to third modes may be selected by the charging capacity estimation value and the charging capacity target value. For example, the first to third modes may be selected by comparing the charging capacity estimation value determined according to the current applied to the secondary battery with the charging capacity target value of the secondary battery. When the charging capacity estimation value exceeds the charging capacity target value, the current applied to the secondary battery may be determined by the second mode or the third mode. When the charging capacity estimation value is the charging capacity target value or less, the current applied to the secondary battery may be determined by the first mode.

Unlike the first method, in the second method, the first mode and the second mode or the third mode may be first selected according to the state of health (SOH), and the second mode or the third mode may be selected by comparing the charging capacity estimation value with the charging capacity target value. For example, the degree of deterioration of the secondary battery (represented, for example, as the state of health) may be calculated by Equation 1. When the SOH in Equation 1 is 10 n % (n is a natural number of 0<n<10), the second or third mode may be selected by comparing the charging capacity estimation value determined by the current applied to the secondary battery with the charging capacity target value of the secondary battery. When the charging capacity estimation value exceeds the charging capacity target value, the current applied to the secondary battery may be determined by the second mode. When the charging capacity estimation value is the charging capacity target value or less, the current applied to the secondary battery may be determined by the third mode.

SOH=(Cap./Cap.ᵢₙₜ)*100 Equation 1:

In one embodiment, Cap. denotes a discharging capacity of the secondary battery, and Cap.ᵢₙₜ denotes a designed capacity of the secondary battery.

The battery charging operation (S3) may include charging the secondary battery with the current determined by the first to third modes. The first mode may include maintaining the current applied to the secondary battery to be identical (or substantially identical) to that previously applied to the secondary battery. The second and third modes may include decreasing the current applied to the secondary battery as compared with that previously applied to the secondary battery. For example, the second mode may include decreasing the current applied to the secondary battery to a reference current (e.g., a pre-set current) according to the degree of deterioration of the secondary battery, and the third mode may include decreasing, in real time, the current applied to the secondary battery according to the degree of deterioration of the secondary battery, changed in real time.

Hereinafter, an embodiment of the present invention and a comparative example are described. However, the following embodiments are merely example embodiments of the present invention, and the scope of the present invention is not limited to the following embodiments.

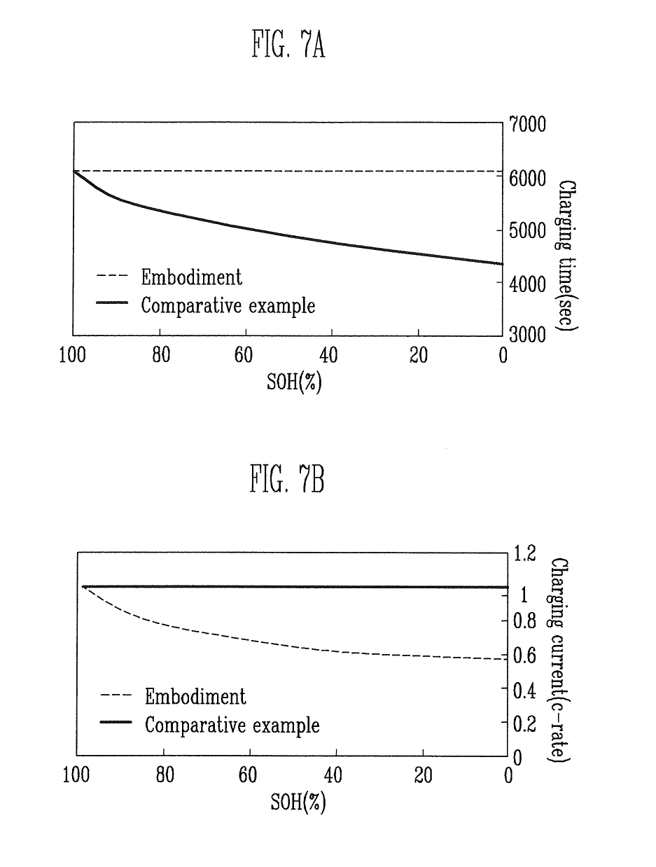

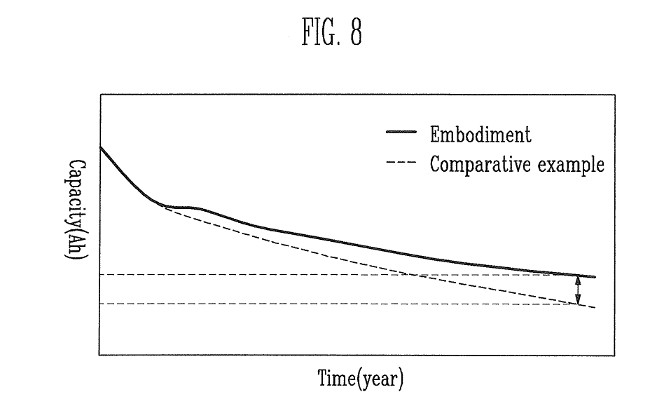

FIG. 7A is a graph showing a charging time with respect to the SOH. FIG. 7B is a graph showing a charging current with respect to the SOH.

In the following embodiment, the secondary battery was charged using a battery charging device and a method according an embodiment of the present invention. In the comparative example, the secondary battery was charged by a constant current/constant voltage (CC-CV) charging method using a battery charging device. In the constant current/constant voltage charging method illustrated by FIGS. 7A and 7B, the final target value of the secondary battery is set to a voltage of 4.2V, and the secondary battery is charged with 10, which is the constant current, until the voltage of the secondary battery reaches the voltage of 4.2V. After the voltage of the secondary battery reaches the voltage of 4.2V, the secondary battery is charged by decreasing the charging current so that the secondary battery maintains the voltage of 4.2V. The 10 means that the C-rate (i.e., a measure of the rate at which a battery is discharged relative to its maximum capacity) is 1, and denotes a current value of charging or discharging. For example, when the designed capacity of the secondary battery is 1000 mAh, the 1 C means that the secondary battery is charged (or discharged) with a current of 1000 mA.

The embodiment and the comparative example used secondary batteries having the same designed capacity, and the secondary batteries were charged by setting the target voltages of the embodiment and the comparative example to be identical to each other. The following Table 1 and FIGS. 7A and 7B are a table and graphs showing charting times (sec) and charging current (C-rate) with respect to the SOH of each of the embodiment and the comparative example.

TABLE 1

| | Embodiment | | Comparative Example | |
|---|---|---|---|---|
| | | Charging | | Charging |
| SOH (%) | Charging time | current | Charging time | current |
| SOH (%) | (sec) | (C-rate) | (sec) | (C-rate) |
| 100 | 6095 | 1 C | 6095 | 1 C |
| 90 | 6095 | 0.85 C | 5566 | 1 C |
| 80 | 6095 | 0.77 C | 5327 | 1 C |
| 70 | 6095 | 0.72 C | 5145 | 1 C |
| 60 | 6095 | 0.68 C | 5001 | 1 C |
| 50 | 6095 | 0.65 C | 4863 | 1 C |
| 40 | 6095 | 0.62 C | 4744 | 1 C |
| 30 | 6095 | 0.60 C | 4635 | 1 C |
| 20 | 6095 | 0.59 C | 4533 | 1 C |
| 10 | 6095 | 0.58 C | 4432 | 1 C |
| 0 | 6095 | 0.57 C | 4337 | 1 C |

FIG. 8 is a graph showing lifetimes according to an embodiment of the present invention and a comparative example.

As described above, the secondary batteries were charged according to Table 1 and FIGS. 7A and 7B, and the discharging capacities of the secondary batteries were identified by setting the C-rate to 1 C. It can be seen that as time elapses, the discharging capacities of the secondary batteries in the embodiment and the comparative example are both decreased due to the deterioration of the secondary batteries. On the other hand, it can be seen that the discharging capacity of the secondary battery in the comparative example is decreased as compared with that in the embodiment. That is, it can be seen that the degree of deterioration of the secondary battery in the embodiment is decreased as compared with that in the comparative example. Further, it can be seen that the lifetime of the secondary battery in the embodiment is improved as compared with that in the comparative example.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A battery charger, comprising:
a sensor configured to monitor a degree of deterioration of a secondary battery;
a current driver configured to apply a current to the secondary battery; and
a controller configured to control the current applied to the secondary battery from the current driver, receive the degree of deterioration of the secondary battery from the sensor, and determine whether to change or maintain the current applied to the secondary battery according to the degree of deterioration of the secondary battery.

2. The battery charger according to claim 1, wherein the controller is configured to determine the current applied to the secondary battery according to a first mode, a second mode, or a third mode.

3. The battery charger according to claim 2,
wherein the controller is configured to select the first mode, the second mode, or the third mode by comparing a charging capacity estimation value determined according to the current applied to the secondary battery with a charging capacity target value of the secondary battery,
wherein the controller is configured to select the second mode or the third mode when the charging capacity estimation value exceeds the charging capacity target value, and
wherein the controller is configured to select the first mode when the charging capacity estimation value is the charging capacity target value or less.

4. The battery charger according to claim 2,
wherein the controller is configured to:
determine the current by the second mode or the third mode when a state of health (SOH) in Equation 1 is 10 n % (n being a natural number of 0<n<10);
determine the current by the first mode when the SOH in Equation 1 is not 10 n % (n being a natural number of 0<n<10); and
select either the second mode or the third mode by comparing a charging capacity estimation value determined according to the current applied to the secondary battery with a charging capacity target value of the secondary battery, with the current being determined by the second mode when the charging capacity estimation value exceeds the charging capacity target value, and with the current being determined by the third mode when the charging capacity estimation value is the charging capacity target value or less,
wherein Equation 1 is: SOH=(Cap./Cap.ᵢₙₜ)*100, and
wherein Cap. denotes a discharging capacity of the secondary battery, and Cap.ᵢₙₜ denotes a designed capacity of the secondary battery.

5. The battery charger according to claim 2, wherein the controller is configured to select the first mode, the second mode, or the third mode by comparing a charging time estimation value determined according to a charging capacity estimation value with a charging time target value of the secondary battery, with the current being determined by the second mode or the third mode when the charging time estimation value is less than the charging time target value, and with the current being determined by the first mode when the charging time estimation value is the charging time target value or more.

6. The battery charger according to claim 2, wherein the controller is configured to, in the first mode, maintain the current applied to the secondary battery to be substantially similar to that previously applied to the secondary battery.

7. The battery charger according to claim 2, wherein the controller is configured to, in the second mode and the third mode, decrease the current applied to the secondary battery as compared with that previously applied to the secondary battery.

8. The battery charger according to claim 7, wherein the controller is configured to, in the second mode, decrease the current applied to the secondary battery to a stored current value according to the degree of deterioration of the secondary battery.

9. The battery charger according to claim 7, wherein the controller is configured to, in the third mode, decrease, in real time, the current applied to the secondary battery according to the degree of deterioration of the secondary battery, changed in real time.

10. The battery charger according to claim 9, wherein the controller is configured to, in the third mode, decrease the current applied to the secondary battery so that the slope of the change in magnitude of the current is inclined according to the degree of deterioration of the secondary battery.

11. A battery charging method, comprising:
determining a degree of deterioration of a secondary battery during a battery monitoring operation ;
determining whether to maintain or change a current applied to the secondary battery according to the degree of deterioration of the secondary battery during a current determining operation; and
charging the secondary battery with the current determined in the current determining operation during a battery charging operation.

12. The battery charging method according to claim 11, wherein, during the battery monitoring operation, determining the degree of deterioration of the secondary battery comprises measuring a voltage or the current of the secondary battery.

13. The battery charging method according to claim 11, wherein, during the current determining operation, the current applied to the secondary battery is determined by a first mode, a second mode, or a third mode of determining the current.

14. The battery charging method according to claim 13, further comprising, during the current determining operation:
comparing a charging capacity estimation value determined according to the current applied to the secondary battery with a charging capacity target value of the secondary battery;
determining the current by the second mode or the third mode when the charging capacity estimation value exceeds the charging capacity target value; and
determining the current by the first mode when the charging capacity estimation value is the charging capacity target value or less.

15. The battery charging method according to claim 13,
wherein, during the current determining operation:
when a state of health (SOH) in Equation 1 is 10 n % (n being a natural number where 0<n<10), the current applied to the secondary battery is determined by either the second mode or the third mode, the second mode or the third mode being selected by comparing the charging capacity estimation value determined by the current applied to the secondary battery with a charging capacity target value of the secondary battery;
when the charging capacity estimation value exceeds the charging capacity target value, the current is determined by the second mode; and
when the charging capacity estimation value is the charging capacity target value or less, the current is determined by the third mode,
wherein Equation 1 is: SOH=(Cap./Cap.ᵢₙₜ)*100, and
wherein Cap. denotes a discharging capacity of the secondary battery, and Cap.ᵢₙₜ denotes a designed capacity of the secondary battery.

16. The battery charging method according to claim 11, further comprising:
charging the secondary battery with the current determined by a first mode, a second mode, or a third mode of determining the current during the battery charging operation;
during the first mode, maintaining the current applied to the secondary battery to be substantially similar to that previously applied to the secondary battery; and
during the second mode and the third mode, decreasing the current applied to the secondary battery as compared with that previously applied to the secondary battery.

17. The battery charging method according to claim 16, further comprising:
during the second mode, decreasing the current applied to the secondary battery to a reference current value according to the degree of deterioration of the secondary battery; and
during the third mode, decreasing, in real time, the current applied to the secondary battery according to the degree of deterioration of the secondary battery, changed in real time.
